(19) United States
(12) Patent Application Publication
(10) Pub. No.: US 2002/0094189 A1
(43) Pub. Date: Jul. 18, 2002

(54) Method and system for E-commerce video editing

(76) Inventors: Nassir Navab, Plainsboro, NJ (US); Xiang Zhang, Lawrenceville, NJ (US); Shih-Ping Liou, West Windsor, NJ (US)

Correspondence Address: Siemens Corporation, Intellectual Property Department, 186 Wood Avenue South, Iselin, NJ, 08830, US

(21) Appl. No.: 09/915,650

(22) Filed: Jul. 26, 2001

Related U.S. Application Data
(60) Provisional application No. 60/220,959, filed on Jul. 26, 2000.

(51) Int. Cl. H04N 9/74; H04N 9/79; H04N 9/87; G11B 27/00; H04N 13/00; H04N 15/00; H04N 5/225; H04N 9/04; H04N 5/232

(52) U.S. Cl. 386/4; 348/207; 348/213; 348/42

(57) ABSTRACT

A video editing system or tool for E-commerce utilizing augmented reality (AR) technology combines real and virtual worlds together to provide an interface for a user to sense and interact with virtual objects in the real world. The AR video editing system is usable in conjunction with an ordinary desktop computer and a low-cost parallel port camera. A known camera calibration algorithm is utilized together with a set of specially designed markers for camera calibration and pose estimation of the markers. OpenGL and VRML (Virtual Reality Modeling Language) for 3D virtual model rendering and superimposition. are utilized. Marker-based calibration is utilized to calibrate the camera and estimate the pose of the markers in the AR video editing system. The system comprises video input/output, image feature extraction and marker recognition, camera calibration/pose estimation, and virtual reality (VR) model rendering/augmentation. This allows a sales person to create and edit customized AR video for product presentation and advertisement. In the video, the sales person can present different aspects of the product while keeping eye-to-eye contact with customers. The system is capable of providing a user with real-time augmented reality feedback while recording a video. The augmented videos can be made available on E-Commerce Web-sites or they can be emailed to customers. Because of the real-time editing capability, the AR video can be directly broadcast on the Internet, for example, for an E-commerce advertisement. Inserted virtual objects can be hyper-linked to product specification WebPages providing more detailed product and price information.

Reference is hereby made to Provisional Patent Application Serial No. 60/220,959 entitled DEVELOPMENT OF A REAL-TIME AUGMENTED REALITY APPLICATION: E-COMMERCE SALES SUPPORT VIDEO EDITING SYSTEM and filed Jul. 26, 2000 in the names of Navab Nassir and Xiang Zhang, and whereof the disclosure is hereby incorporated herein by reference.

The present invention relates generally to e-commerce and, more specifically, to a sytem or apparatus and a method for video editing, especially for e-commerce sales activity.

It is herein recognized that, at the present time, many promotional e-mails soliciting customer participation in e-commerce today are typically rather long and tend to be boring, making it difficult to attract and hold a potential customer's attention.

On object of the present invention is to turn Web customers from “window shoppers” into buyers. In accordance with an aspect of the invention, an interactive sales model informs customers, gives them individualized attention, and helps to close the sale at the customer's request. In one sense, sales agents should ideally have in-person meetings with all prospective customers likely to be interested in new products or features. However, this may not be desirable or feasible, given time and budget constraints and it is herein recognized as the next best thing is for sales agents to send promotional e-mails to their prospective customers.

In accordance with an aspect of the invention, a video editing system or tool for E-commerce utilizing augmented reality (AR) technology combines real and virtual worlds together to provide an interface for a user to sense and interact with virtual objects in the real world. The AR video editing system is usable in conjunction with an ordinary desktop computer and a low-cost USB or parallel port video camera. A known camera calibration algorithm is utilized together with a set of specially designed markers for camera calibration and pose estimation of the markers. OpenGL and VRML (Virtual Reality Modeling Language) for 3D virtual model rendering and superimposition. are utilized. Marker-based calibration is utilized to calibrate the camera and estimate the pose of the markers in the AR video editing system. The system comprises video input/output, image feature extraction and marker recognition, camera calibration/pose estimation, and virtual reality (VR) model rendering/augmentation. This allows a sales person to create and edit customized AR video for product presentation and advertisement. In the video, the sales person can talk to customers and present different aspects of the product while keeping eye-to-eye contact with customers. The augmented videos can be made available on E-Commerce Web-sites or they can be emailed to customers. Inserted virtual objects can be hyper-linked to product specification WebPages providing more detailed product and price information.

The invention will be more fully understood from the following detailed description of preferred embodiments, in conjunction with the Drawing, in which

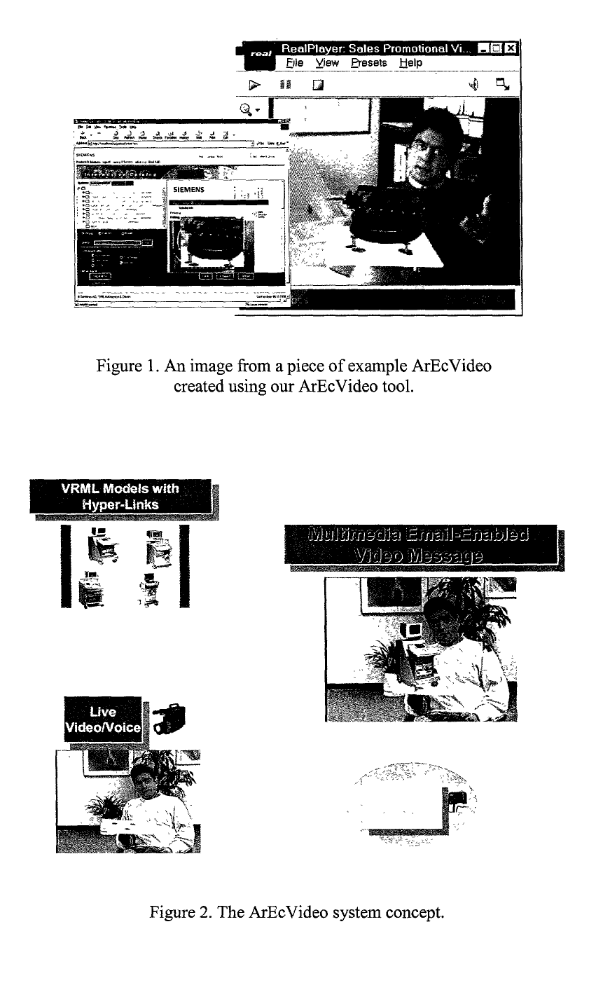

FIG. 1 shows an image from a portion of an exemplary ArEcVideo created using the ArEcVideo tool in accordance with the present invention;

FIG. 2 shows a graphical illustration of the ArEcVideo system concept in accordance with the principles of the present invention;

FIG. 3 shows in diagrammatic form a system overview of the ArEcVideo editing tool in accordance with the principles of the present invention;

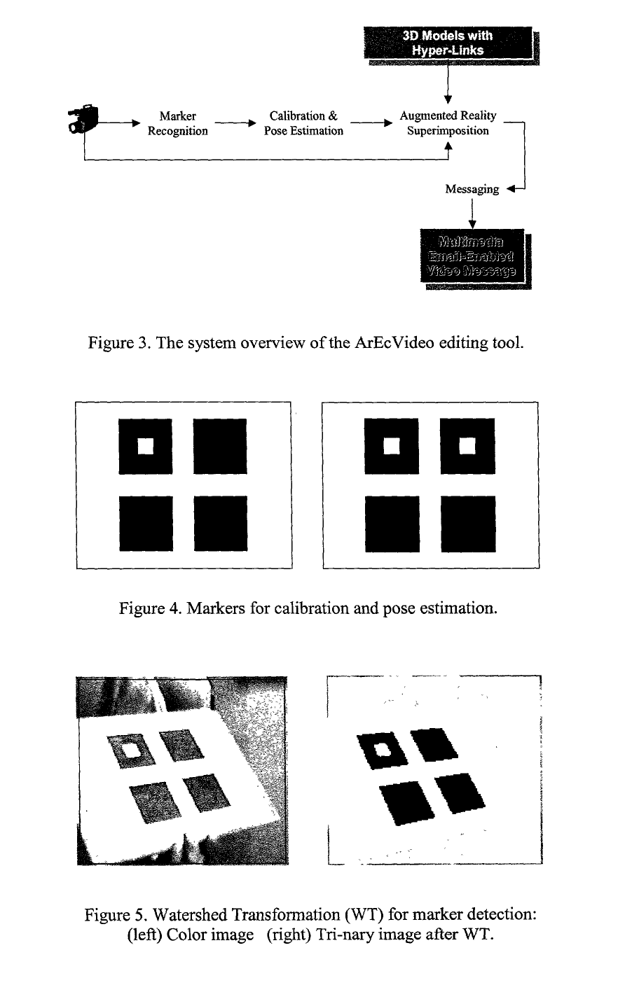

FIG. 4 shows markers for calibration and pose estimation in accordance with the principles of the present invention;

FIG. 5 shows Watershed Transformation (WT) for marker detection: (left) Color image (right), Tri-nary image after WT;

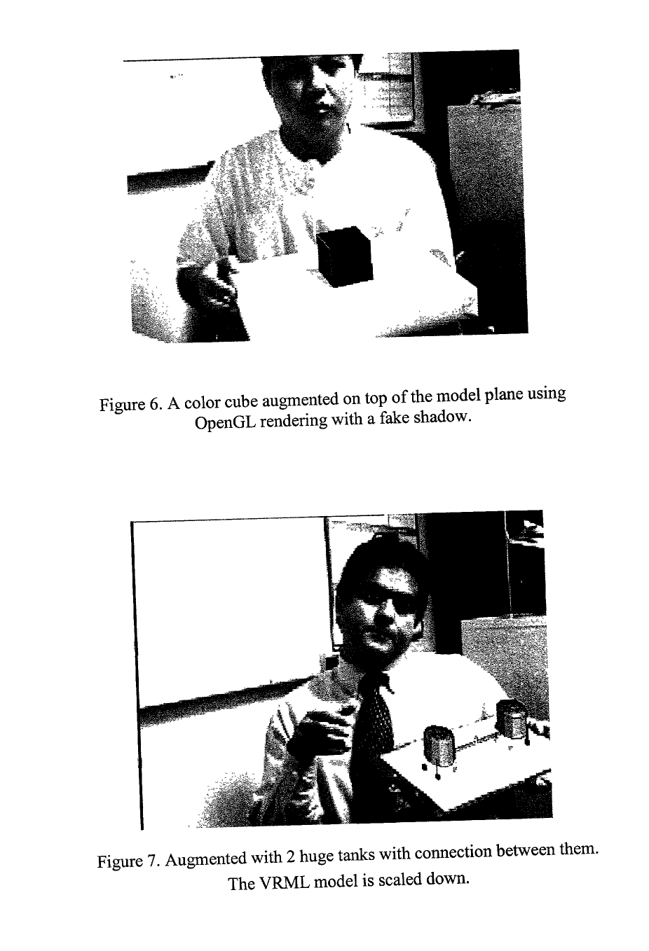

FIG. 6 shows a color cube augmented on top of the model plane using OpenGL rendering with a fake shadow in accordance with the principles of the present invention;

FIG. 7 shows an image augmented with 2 huge tanks with connection between them, in accordance with the principles of the present invention;

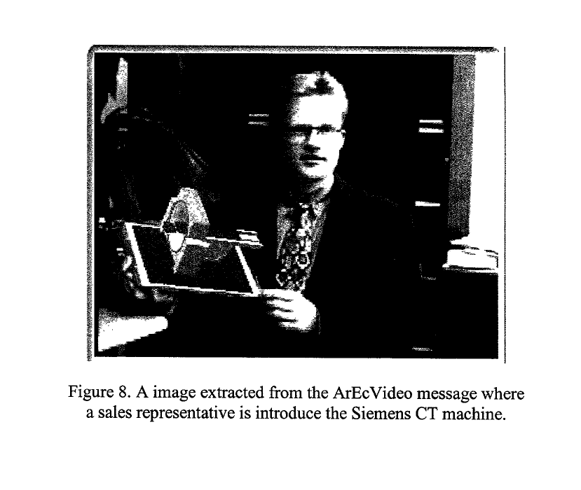

FIG. 8 shows an image extracted from the ArEcVideo message, in accordance with the principles of the present invention, where a sales representative is shown introducing a product; and

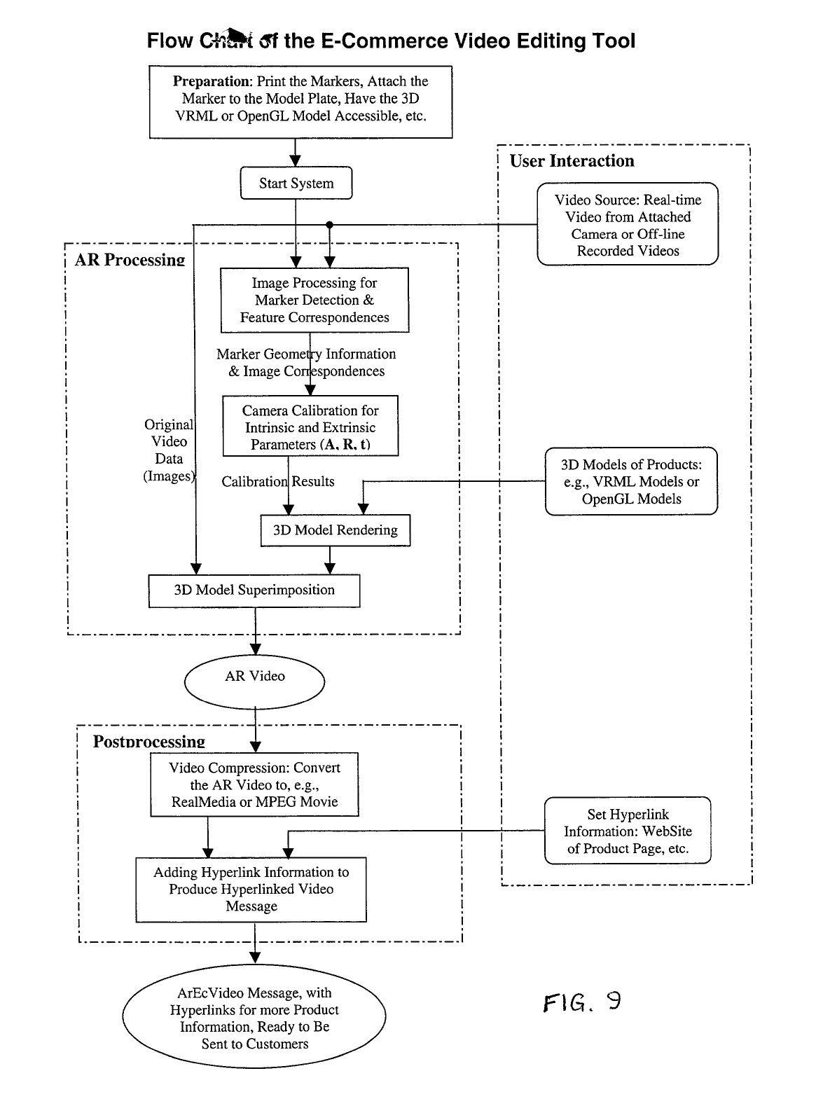

FIG. 9 shows a Flow Chart of an E-Commerce Video Editing Tool in accordance with the principles of the present invention.

In accordance with the principles of the invention, it is herein recognized that a good promotional message should exhibit characteristics including the following.

Customer-Specific Content

A short message briefly describes how the new product features apply to the specific situation of the customer, addressing any known individual concerns.

Personalized

A personalized greeting and communication is included from a person familiar to the customer.

Interactive

The customer can find more information by following hyperlinks embedded in the streaming presentation. When the customer follows the links, the sales agent can be notified automatically.

Media-Rich Communication

Appropriate use of various media, ranging from PowerPoint slides to video to 3-diimensional (3D)-models, along with effective annotations and views help in effectively communicating the message.

Cost-Effective Production

In accordance with an aspect of the invention, a tool allows a sales person to readily create such promotional presentation in a matter of minutes.

In accordance with an aspect of the invention, a real-time augmented reality (AR) application is described, including electronic commerce (E-Commerce) sales support video editing, hereinafter referred to as ArEc Video. In accordance with a principle of the invention, AR technology is applied to produce E-commerce advertisement video messages that include characteristics listed above. AR herein is the computer technology that presents the scenes of the real world, such as a video/image of a familiar face of a sales agent, augmented with the views of the virtual world objects, such as various 3D product models created and presented using computers. In most of AR views, the positions and appearances of virtual objects are closely related to real world scenes. See, for example, Kato, H. and Billinghurst, M., Marker Tracking and HMD Calibration for a Video-based Augmented Reality Conferencing System. Proceedings of the 2^{nd} IEEE and ACM International Workshop on Augmented Reality '99, 1999, IEEE Computer Society, 1999, 125-133; Klinker, G., Stricker, D., and Reiners, D., Augmented Reality: A Balancing Act between High Quality and Real-Time Constraints. Mixed Reality: Merging Real and Virtual Worlds. Ed. Ohta, Y. and Tamura, H., Ohmsha, Ltd., 1999, 325-346; and Koller, D., Klinker, G., Rose, E., Breen, D., Whitaker, R., and Tuceryan, M., Real-time Vision-Based Camera Tracking for Augmented Reality Applications. Proceedings of the Symposium of Virtual Reality Software and Technology (VRST-97), 1997, 87-94.

Reference is also made to Jethwa, M., Zisserman, A., and Fitzgibbon, A., Real-time Panoramic Mosaics and Augmented Reality. Proceedings of the 9^{th} British Machine Vision Conference, 1998, 852-862; and Navab, N., Bani-Hashemi, A., and Mitschke, M., Merging Visible and Invisible: Two Camera-Augmented Mobile C-arm (CAMC) Applications. Proceedings of the 2^{nd} IEEE and ACM International Workshop on Augmented Reality '99, 1999, 134-141.

ArEcVideo can be created by using the camera calibration and motion tracking technologies to track the motion and compute the pose of the visual marker held in the hand of a sales person. Then the virtual 3D model of the product can be inserted into the video on top of the marker plate, based on camera calibration and motion tracking results. A flow chart showing the working flow in accordance with the present invention is shown in FIG. 9. The virtual object moves and turns with the plate as if it were real and placed on top of the plate, whereby the person in the video can move and present different aspects of the virtual 3D object. In a segment of ArEcVideo, a sales person can talk and present different aspects of the product, while maintaing eye-to-eye contact with the viewer/customer. The inserted virtual objects in the AR videos are further hyper-linked to the corresponding Web pages, providing interested customers more detailed product and price information.

It will be understood that sound, usually synchronized with the video, is typically recorded together with the video information and the term video as used herein should be understood to mean video with accompanying sound where applicable.

A user of the present invention, typically a sales persons, need not necessarily be knowledgeable in computer vision/video/image processing, and can readily and easily create and edit customized ArEcVideos for presentation and advertisement using ArEcVideo tools. These AR videos can be made available on a company's E-Commerce Web-site or sent to customers by e-mail as shown in FIGS. 1 and 2.

The present invention and principles thereof will be explained by way of exemplary embodiments such as a prototype ArEcVideo tool in accordance with the principles of the invention. Using the prototype ArEcVideo tool, an AR video can be produced using an ordinary desktop or laptop computer attached to a low-cost video camera, such as a USB web camera in real-time. With the user-friendly interface (UI) of the ArEcVideo editing tool, non-IT (information technology) professionals without any special training can use this system to easily create their own advertising ArEcVideos.

The prototype ArEcVideo editing tool is a software system comprising the following five subsystems: i) video input/output, ii) image feature extraction and marker recognition, iii) camera calibration/pose estimation, iv) augmented reality superimposition, and v) messaging.

FIG. 3 depicts the structure of the system. In the following sections, details are disclosed of how each sub-system is implemented. Marker-based calibration is used to calibrate the camera and estimate the pose of the markers in the AR video editing system.

In the present application, real-time performance is highly desirable and is the preferred mode. Nevertheless, even with a certain amount of delay, the invention can still be very useful. Real-time performance as herein used means that the AR video process is carried out and the result displayed at the same time the video data is captured. the process being completed right after the video capture procedure has finished. Therefore, the user can preview the ArEcVideo result while presenting and performing for the video, so that the user can adjust their position, etc., accordingly, and the user can record the resulting ArEcVideo at the same time. Integration of virtual objects into the scene should be fast and effective. Most current real-time AR systems are built on high-end computing systems such as SGI workstations that are equipped with hardware accelerators for image capturing, processing, and rendering. The system in accordance with the present invention has real-time performance capability and is developed and adapted for an ordinary desktop computer with a low-cost PC camera. There is a further important aspect of the real-time performance of the ArEcVideo production in accordance with the present invention; since the result is being produced at the same time as the user is performing the product presentation and advertisement, the resulting ArEcVideo can thus be broadcast through the network to a plurality of interested customers at the same time.

To use the system in accordance with the present invention, the sales person will hold on his hand a plate with specially designed markers, and choose a 3D model of his product to be marketed or sold. As the sales person moves the plate, the system automatically superimposes the 3D model on top of the plate in live video images and displays the superimposed video on screen. The sales person can then explain features of this product, or even interact with an animated 3D model as if a real product were standing on the plate. It is emphasized that, in accordance with the principles of the invention, real-time augmented reality feedback is provided while the video (including any applicable sound) is being recorded. As a result, the system is capable of providing real-time editing of the video and the virtual objects integrated into it.

In accordance with an embodiment of the invention, the system can be implemented in such a way that after the sales person finishes talking, it automatically converts the composed video into a streaming video format. The user can then send the resulting video as an e-mail to his prospective customer (see FIG. 2).

Because of the real-time editing capability, the augmented reality video can be broadcast directly on the Internet for a web or Internet E-commerce commercial or advertisement.

Most digital video cameras can be used as the real-time video source. For example, most of USB (universal serial bus) cameras with vfw (video for Windows) based drivers can be low cost video cameras with acceptable performance and image quality. Also, pre-recorded video segments can be utilized as the video source, including sound where applicable.

A suitable set of markers has been designed in accordance with the principles of the invention for easy detection and recognition. FIG. 4 shows some examples. There are four black squares with known sizes. The centers of some of the black squares are white so that the computer can determine the orientation of the markers and distinguish one marker from another. This feature also enables the superimposition of different 3D models on to different model planes. To prepare the model plane, the user can, for example, print out one of the markers on a piece of white paper and paste it to a plate.

In an exemplary embodiment in accordance with the principles of the inventoin, the 16 corners and/or the four central points of the markers are utilized for calibration and pose estimation. An algorithm to quickly find the feature points of the markers is critical to the present real-time application. We use the watershed transformation (WT) algorithm, which follows below,) to detect the markers and then locate for corresponding points. For more details of this algorithm, see Beucher, S., Lantuejoul, C., Use of Watersheds in Contour Detection. International Workshop on image processing, real-time edge and motion detection/estimation, Sep. 1979, Rennes, France.

FIG. 5 shows an example of the results obtained using the WT algorithm. In the present embodiment, an adaptive threshold is used, which varies with the image intensity distribution in the working region, for extracting the features of the markers. Therefore, it eliminates part of the instability of marker detection caused by varying illumination.

In accordance with a principle of the invention, the following WT algorithm is utilized to extract the markers from the image:

When thresholding the selected area pixel by pixel, with an adaptive threshold determined by the intensities of the pixels inside the selected part of the image,

1. If the intensity of a pixel is higher than the threshold, the pixel is marked ‘HIGH’ (colored white);

2. If the intensity of a pixel is lower than the threshold and the pixel is a boundary pixel, then the pixel is marked ‘SUBMERGED’ (colored gray);

3. If the intensity of a pixel is lower than the threshold, and at least one of its surrounding pixels ‘SUBMERGED’, then this pixel is also ‘SUBMERGED’ (colored gray);

4. If the intensity of a pixel is lower than the threshold, but none of its surrounding pixels is ‘SUBMERGED’ or boundary pixel, then this pixel is marked ‘LOW’ (colored black);

5. The output of WT is an image with three colors (white, gray, and black). The four black patches constitute the square markers; and

6. To detect the markers in the next frame of the video, the working area is updated based on an expanded bounding box of the markers in the current frame.

FIG. 5 (right) shows the corresponding WT result. The markers clearly stand out from the WT image. A prediction-correction method is applied to the WT image to accurately locate the positions of the centers of the black squares in the image. Correspondences of marker feature points (corners and centers of the blocks in the image) of sub-pixel accuracy can be obtained using Canny edge detection. This is an image processing method to find edges of an object from images. See Trucco, E. and Verri, A., Introductory Techniques for 3-D Computer Vision, 1998 for more details and line fittings.

See the camera calibration algorithm disclosed in Zhang, Z., Flexible Camera Calibration by Viewing a Plane from Unknown Orientations. Proceedings of the Seventh International Conference on Computer Vision, 1999, 666-673 for calibration and pose estimation. This algorithm, described below and also herein incorporated by reference, requires at least four coplanar 3D points and their projections on each image. Note that by obtaining the rotation matrix (noted as R) and translation vector (noted as t) frame by frame, the method in accordance with the invention does not need any filtering process to track the motion of the markers. Briefly, describe this algorithm as described as follows:

The symbol list:

M—a point in the real world of 3D space, presented with a homogeneous coordinate system notation.

m—the image correspondence of point M.

A—The camera intrinsic matrix.

R—The rotation matrix of the camera pose related to the 3D world.

t—The translation vector of the camera pose related to the 3D world.

H—The homography matrix that determines the projection of a set of co-planar 3D points on to an image plane.

The pinhole camera model describes the relationship between a 3D point, M=[X, Y, Z, 1]^{T}, and its 2D projection, m=[u, v, 1]^{T}, all expressed in homogeneous system, on the image plane as

sm=A[Rt]M, (1)

where s is a scaling factor, R=[r₁ r₂ r₃] the 3×3 rotation matrix, t the 3×1 translation vector, and A the camera intrinsic matrix given by

$$A = [ \begin{matrix}α & γ & {u}_{0} \\ 0 & β & {v}_{0} \\ 0 & 0 & 1\end{matrix} ] ,$$

with (u₀, v₀) be the coordinates of the camera principal center on the image plane, α and β the focal lengths in image u and v directions, and γ the skewness of the two image axes. Since all 3D points are on the model plane, we construct the global coordinate system with Z=0 on the model plane. Thus Equation (1) can be rewritten as

$$\begin{matrix}s m = {A [ \begin{matrix}{r}_{1} & {r}_{2} & {r}_{3} & t\end{matrix} ] [ \begin{matrix}X & Y & 0 & 1\end{matrix} ]}^{T} \\ = {A [ \begin{matrix}{r}_{1} & {r}_{2} & t\end{matrix} ] [ \begin{matrix}X & Y & 1\end{matrix} ]}^{T}\end{matrix} \qquad ( 2 )$$

or

sm=H[X Y 1]^{T}, (3)

where H is the 3×3 homography describing the projection from the model plane to the image plane. We note

H=[h₁ h₂ h₃]=λA[r₁ r₂ t]. (4)

If at least four coplanar 3D points and their projections are known, then the homography H can be determined up to a scaling factor. Then the intrinsic matrix A can be extracted from Eq.(4) by making use of the fact that r₁ and r₂ are orthonormal. In the case that the intrinsic matrix A is determined, the rotation matrix R and translation vector t can be obtained. Additional detail on this calibration algorithm can be found in Zhang, Z., Flexible Camera Calibration by Viewing a Plane from Unknown Orientations. Proceedings of the Seventh International Conference on Computer Vision, 1999, 666-673, cited above.

Before we use these A, R, and t for AR, we optimize the data by minimizing the following functional for a set of n images each with m known coplanar 3D points:

$${\sum }_{i = 1}^{n} {\sum }_{j = 1}^{m} {‖ {m}_{i j} - {m}^{′} ( A , {R}_{i} , {t}_{i} , {M}_{j} ) ‖}^{2} , \qquad ( 5 )$$

where m′ (A, Rᵢ, tᵢ, Mⱼ) is the projection of point Mⱼ in image i. This nonlinear optimization problem is solved with the Levenberg-Marquardt Algorithm (a numerical algorithm for solving non-linear optimization problems, see Press, W., Teukolsky, S., Woo, M., and Flannery, B., Numerical Recipes in C: The Art of Scientific Computing, 2^{nd} Edition, 1992.

With regard to augmented reality superposition, the user can augment the scene with either an OpenGL 3D model or a VRML 3D model using the system in accordance with the invention, depending on the actual situation. Such functionality provides flexibility to the users.

The functionality of superimposing VRML objects is implemented with the Blaxxun Contact 3D External Authoring Interface (EAI) and VRML Browser. To this end, a VRML Transform node is created and the file that defines the VRML model as an Inline url node of this Transform node is set. See Ames, A., Nadeau, D., and Moreland, J., VRML Sourcebook, 2^{nd} ed. John Wiley & Sons, Inc., 1997. To render the VRML model, a popup window is created which contains the Blaxxun VRML browser as an active X control, herein referred to as the VRML rendering window. The viewpoint of the VRML rendering window is set at the origin of the camera coordinate system, other rendering parameters are set based on the camera intrinsic parameters. With the Blaxxun EAI (External Application Interface), one can dynamically change the translation and orientation of the rendered VR object according to R and t. The VRML model rendered in the VRML rendering window appears like it is at the position of the model plane viewed through the camera lens. By superimposing the VRML rendering window on top of the original image, the AR image is obtained showing that the VRML model sitting on top of the model plane.

During the VRML rendering, hyper-links in the original VRML model are extracted, time-stamped, and stored in a separate meta file, if the corresponding part is visible.

For messaging, after the recording is stopped, the system can automatically convert the resulting AVI file into a RealMedia file, and creates a SMIL file using the meta file generated in the previous step. Both RealMedia and SMIL files can then be uploaded to the server. E-mail with a URL link to the SMIL file is sent to selected recipients.

By way of exemplary embodiments some examples follow of the AR video produced using the system herein described in accordance with the present invention. FIG. 6 is a snapshot showing that a color cube is augmented on top of the model plane. This color cube is modeled using OpenGL. It is apparaent that the virtual reality (VR) model is seamlessly added into the image.

FIG. 7 shows that the scene is augmented with two connected huge tanks. It is also possible to insert an animated 3D VRML model on top of the model plane.

FIG. 8 shows the ArEcVideo for advertisement, where the sales representative is introducing a new product.

As shown in FIG. 9, certain preparations are typically performed prior to actually starting the system. These may include printing markers and attaching them to the model plate, arranging that the 3D VRML and/or OpenGL Model are accessible, and so forth.

When the system is set in operation, video data from an attached camera or from off-line recorded videos is provided for image processing to be carried out for detecting markers and ensuring correspondence between features, resulting in data representing marker geometry information and image correspondences. The data is then utilized for camera calibration for intrinsic and extrinsic parameters, resulting in calibration results. Data from 3D models of objects, such as products, including for example, VRML Models or OpenGL Models is combined with the above-mentioned calibration results so as to provide 3D model rendering. This is combined with original video data referred to above so as to perform 3D model superimposition, resulting in an AR Video.

In a postprocessing phase, the AR Video is subject to video compression wherein the AR Video is converted, for example, into RealMedia or MPEG Movie. Hyperlink information can be set at this point and is added to the compressed AR Video data so as to produce a hyperlinked video message. This is then utilized to produce an ArEcVideo Message, with Hyperlinks for more Product Information which is then ready to be sent to customers.

It will be understood that the data processing and storage are contemplated to be performed by a programmed computer, such as a general-purpose computer such as a personal computer, suitably programmed.

While the present invention has been described by way of exemplary embodiments, it will be understood that various changes and substitutions may be made by one of ordinary skill in the art to which it pertains without departing from the spirit of the invention and that such changes and the like are intended to be covered by the scope of the claims following.

What is claimed is:

1. A video editing system or tool for E-commerce, said system utilizing augmented reality (AR) technology for combining real and virtual worlds together to provide an interface for a user to sense and interact with virtual objects in the real world, said system comprising:
a programmable computer for performing data processing of video and calibration data;
a source of video data coupled to said computer;
a set of markers for calibration of said camera and for pose estimation of said markers, for providing calibration results;
a source of a 3-dimensional (3-D) image data model for a product;
said computer utilizing said 3-D image data and said calibration results for rendering a 3D model; and
said computer utilizing said 3D model and said video data for generating a 3-D model with superposition of said 3D model and said video data so as to provide an AR video.

2. A video editing system in accordance with claim 1, wherein said (3-D) image data model for a product comprises a VRML model.

3. A video editing system in accordance with claim 1, wherein said (3-D) image data model for a product comprises an OpenGL model.

4. A video editing system in accordance with claim 1, wherein said a source of video data is a video camera.

5. A video editing system in accordance with claim 1, wherein said said computer utilizing said 3D model and said video data provides marker-based calibration to calibrate the camera and estimate the pose of the markers in the AR video editing system.

6. A video editing system in accordance with claim 1, wherein said said computer utilizing said 3D model and said video data provides image feature extraction and marker recognition.

7. A video editing system in accordance with claim 1, wherein said said computer utilizing said 3D model and said video data provides virtual reality (VR) model rendering/augmentation.

8. A video editing system in accordance with claim 1, wherein said computer performs video compression on said AR video.

9. A video editing system in accordance with claim 1, wherein said computer performs video compression on said AR video for converting said AR video to at least one of RealMedia and MPEG Movie format.

10. A video editing system in accordance with claim 1, wherein said computer adds inputted hyperlink information to said AR video after said converting said AR video, so as to produce a hyperlinked video message.

11. A video editing system in accordance with claim 10, wherein said computer data provides hyper-linking of said AR video to product specification WebPages.

12. A method for video editing comprising the steps of:
obtaining video image data from a source;
extracting feature information data from said video image data;
extracting marking recognition data from said video image data;
utilizing said information data and said recognition data to derive calibration data and pose estimation data for said source;
deriving 3-dimensional (3-D) model data for an object;
utilizing said calibration data, said pose estimation data, said video image data, and said 3-dimensional (3-D) model data for an object to perform volume rendering (VR) and superposition to produce an artificial reality (AR) image.

13. A method for video editing as recited in claim 12, comprising the steps of:
setting hyperlink information;
compressing said AR video so as to produce a compressed AR video;
adding said hyperlink information to said compressed AR video so as to produce an ArEcVideo message with hyperlinks.

14. A method for video editing as recited in claim 13, wherein said step of setting hyperlink information comprises setting hyperlink information for hyperlinks providing product information associated with said object.

15. A method for video editing as recited in claim 12, comprising the step of:
sending said ArEcVideo message with hyperlinks on the Web.

16. A system for video editing comprising:
means for obtaining video image data from a source;
means for extracting feature information data from said video image data;
means for extracting marking recognition data from said video image data;
means for utilizing said information data and said recognition data to derive calibration data and pose estimation data for said source;
means for deriving 3-dimensional (3-D) model data for an object; and
means for utilizing said calibration data, said pose estimation data, said video image data, and said 3-dimensional (3-D) model data for an object to perform volume rendering (VR) and superposition to produce an artificial reality (AR) image.

17. A system for video editing as recited in claim 16, comprising:
means for setting hyperlink information;
means for compressing said AR video so as to produce a compressed AR video; and
means for adding said hyperlink information to said compressed AR video so as to produce an ArEcVideo message with hyperlinks.

18. A system for video editing as recited in claim 17, wherein said means for setting hyperlink information comprises means for setting hyperlink information for hyperlinks providing product information associated with said object.

19. A system for video editing as recited in claim 18, comprising:
means for sending said ArEcVideo message with hyperlinks on the Web.

20. A system for video editing as recited in claim 16, wherein said means for obtaining video image data from a source comprises a video camera.

21. A system for video editing as recited in claim 16, wherein said means for obtaining video image data from a source comprises a source of a stored video image.

22. A video editing system or tool for E-commerce, said system utilizing augmented reality (AR) technology for combining real and virtual worlds together to provide an interface for a user to sense and interact with virtual objects in the real world, said system comprising:
a programmable computer for performing data processing of video and calibration data in real time;
a source of video data coupled to said computer;
a set of markers for calibration of said camera and for pose estimation of said markers, for providing calibration results;
a source of a 3-dimensional (3-D) image data model for a product;
said computer utilizing said 3-D image data and said calibration results for rendering a 3D model; and
said computer utilizing said 3D model and said video data for generating a 3-D model with superposition of said 3D model and said video data so as to provide an AR video in real time relative to said video data.

23. A video editing system in accordance with claim 1, wherein said (3-D) image data model for a product comprises a VRML model.

24. A video editing system in accordance with claim 1, wherein said (3-D) image data model for a product comprises an OpenGL model.

25. A video editing system in accordance with claim 1, wherein said a source of video data is a video camera.

26. A video editing system in accordance with claim 1, wherein said said computer utilizing said 3D model and said video data provides marker-based calibration to calibrate the camera and estimate the pose of the markers in the AR video editing system.

27. A video editing system in accordance with claim 1, wherein said said computer utilizing said 3D model and said video data provides image feature extraction and marker recognition.

28. A video editing system in accordance with claim 1, wherein said said computer utilizing said 3D model and said video data provides virtual reality (VR) model rendering/augmentation with real time editing capability.

29. A video editing system in accordance with claim 1, wherein said computer performs video compression on said AR video.

30. A video editing system in accordance with claim 1, wherein said computer performs video compression on said AR video for converting said AR video to at least one of RealMedia and MPEG Movie format.

31. A video editing system in accordance with claim 1, wherein said computer adds inputted hyperlink information to said AR video after said converting said AR video, so as to produce a hyperlinked video message.

32. A video editing system in accordance with claim 10, wherein said computer data provides hyper-linking of said AR video to product specification WebPages.

33. A method for video editing comprising the steps of:
obtaining video image data from a source;
extracting feature information data from said video image data;
extracting marking recognition data from said video image data;
utilizing said information data and said recognition data to derive calibration data and pose estimation data for said source;
deriving 3-dimensional (3-D) model data for an object; and
utilizing said calibration data, said pose estimation data, said video image data, and said 3-dimensional (3-D) model data for an object to perform volume rendering (VR) and superposition to produce an artificial reality (AR) image.

34. A method for video editing in accordance with claim 33 wherein said step of obtaining video image data includes a step of obtaining accompanying sound data.

35. A system for video editing comprising:
means for obtaining video image data, including accompanying sound data from a source;
means for extracting feature information data from said video image data;
means for extracting marking recognition data from said video image data;
means for utilizing said information data and said recognition data to derive calibration data and pose estimation data for said source;
means for deriving 3-dimensional (3-D) model data for an object; and
means for utilizing said calibration data, said pose estimation data, said video image data, and said 3-dimensional (3-D) model data for an object to perform volume rendering (VR) and superposition to produce an artificial reality (AR) image.

36. A video editing system in accordance with claim 1, wherein said source of video data comprises a source for associated sound data.

37. A video editing system in accordance with claim 36, wherein said source of associated sound data comprises a microphone.

38. A video editing system in accordance with claim 16, wherein said source provides sound data and wherein said means for obtaining video image data comprises means for obtaining sound data from said source.

39. A video editing system in accordance with claim 22, wherein said video data includes associated sound data.

40. A video editing system in accordance with claim 33, wherein said step of obtaining video image data comprises a step of obtaining associated sound data from said source.

41. A method for video editing as recited in claim 12, said method being carried out in real-time using an ordinary desktop or laptop PC type of computer.

42. A method for video editing as recited in claim 12, to be carried out in real-time that enables a user to rehearse and get visual feed-back in real time.

43. A system for video editing as recited in claim 12, for producing said AR video in real time, said video being ready to be broadcast through a network in real time.

44. A method for video editing comprising the steps of:
obtaining video image data and associated synchronized sound data from a source;
extracting feature information data from said video image data;
extracting marking recognition data from said video image data;
utilizing said information data and said recognition data to derive calibration data and pose estimation data for said source;
deriving 3-dimensional (3-D) model data for an object; and
utilizing said calibration data, said pose estimation data, said video image data, and said 3-dimensional (3-D) model data for an object to perform volume rendering (VR) and superposition so as to produce an artificial reality (AR) image in real time.

45. A method for video editing as recited in claim 44 including a step of providing said associated synchronized sound data to accompany said AR image in real time.
